(19) United States
(12) Patent Application Publication
(10) Pub. No.: US 2005/0215283 A1
(43) Pub. Date: Sep. 29, 2005

(54) Hand-held electronic devices configured to provide image data in an internet protocol format and related display devices and mehods

(76) Inventor: William O. Camp JR., Chapel Hill, NC (US)

Correspondence Address: Scott C. Hatfield;Myers Bigel Sibley & Sajovec, Post Office Box 37428, Raleigh, NC, 27627, US

(21) Appl. No.: 10/809,179

(22) Filed: Mar. 25, 2004

(51) Int. Cl. H04M 1/00

(52) U.S. Cl. 455/556.2

(57) ABSTRACT

A hand-held electronic device may include memory, a transmitter, and a controller. The memory may be configured to store image data within the hand-held electronic device, and the transmitter may be configured to provide a wireless link with a remote electronic display. The controller may be coupled to the memory and to the transmitter. Moreover, the controller may be configured to provide the image data in an Internet protocol format, and the transmitter may be configured to transmit the image data over the wireless link in the Internet protocol format. Related display devices and methods are also discussed.

### FIELD OF THE INVENTION

The present invention relates to the field of electronics and more particularly to methods, devices, and systems for displaying information.

### BACKGROUND OF THE INVENTION

While many hand-held electronic devices such as radiotelephones and personal digital assistants continue to get smaller, the desire to display greater amounts of information is increasing. Accordingly, a demand for ever larger displays may be in conflict with a demand for ever smaller hand-held electronic devices. For example, increased use of text messaging in cellular communications may increase demand for larger mobile terminal displays to facilitate use and/or viewing of this information. In addition, increases in data services provided in hand-held electronic devices may increase demand for larger mobile terminal displays to facilitate viewing by more than one person at a time.

### SUMMARY

According to embodiments of the present invention, a hand-held electronic device may include memory, a transmitter, and a controller. The memory is configured to store image data within the hand-held electronic device, and the transmitter is configured to provide a wireless link with a remote electronic display. The controller is coupled to the memory and to the transmitter. Moreover, the controller is configured to provide the image data in an Internet protocol format, and the transmitter is configured to transmit the image data over the wireless link in the Internet protocol format.

In addition, a user interface may be coupled to the controller with the user interface being configured to accept user input of pointer commands and with the controller and transmitter being configured to transmit the pointer commands over the wireless link to the remote electronic display. The pointer commands may be transmitted in the Internet protocol format, or the pointer commands may be transmitted in a format other than the Internet protocol format. Moreover, the transmitter may be a short range transmitter, and the hand-held electronic device may also include a long range transceiver configured to provide long-range communications such as radio telephone communication and/or packet switched data communications.

The transmitter may be configured to provide a wireless link according to at least one of a WiFi standard, a BlueTooth standard, and/or an infrared standard, and the Internet protocol format may be HTML and/or XML. The controller may also provide at least one of a contacts database, a calendar, an e-mail transmitter/receiver, a digital music player, a task list, and/or a wireless internet browser, and the image data may include a slide presentation.

According to additional embodiments of the present invention, an electronic display device may include a display and an internet protocol browser. The display is configured to display electronic data. The Internet protocol browser is configured to receive image data and pointer commands from a hand-held electronic device without a wired coupling to the hand-held electronic device. The image data is received at the Internet protocol browser in an Internet protocol format, and the Internet protocol browser is configured to provide the image data visually using the display responsive to the pointer commands. More particularly, the display may be a monitor or projector.

Moreover, the pointer commands may be received at the Internet protocol browser in the Internet protocol format, or the pointer commands may be received at the Internet protocol browser in a format other than the Internet protocol format. In addition, the Internet protocol format may be HTML and/or XML, and the image data may be a slide presentation.

According to still additional embodiments of the present invention, a method of providing a visual presentation using a hand-held electronic device includes storing image data within the hand-held electronic device. The image data is provided in an Internet protocol format, and the image data is transmitted over a wireless link to a remote electronic display in the Internet protocol format.

In addition, accepting user input of pointer commands may be accepted, and the pointer commands may be transmitted over the wireless link to the remote electronic display. The pointer commands may be transmitted in the Internet protocol format, or the pointer commands may be transmitted in a format other than the Internet protocol format.

The image data is transmitted using a short range protocol, and long-range wireless communications may also be provided. More particularly, providing long range wireless communications may include providing radiotelephone communications and/or packet switched communications. Moreover, transmitting the image data may include transmitting the image data using at least one of a WiFi standard, a BlueTooth standard, and/or an infrared standard, and the Internet protocol format may be HTML and/or XML.

At least one of a contacts database, a calendar, an e-mail transmitter/receiver, a digital music player, a task list, and/or a wireless internet browser may also be provided, and the image data may be a slide presentation.

According to yet additional embodiments of the present invention, a method of operating an electronic display device may include receiving image data and pointer commands from a hand-held electronic device without a wired coupling to the hand-held electronic device. Moreover, the image data is received in an Internet protocol format, and the image data is provided visually responsive to the pointer commands.

More particularly, the image data may be provided using at least one of a monitor and/or a projector, and the pointer commands may be received at the Internet protocol browser in the Internet protocol format. In addition, the pointer commands may be received at the Internet protocol browser in a format other than the Internet protocol format. The Internet protocol format may be HTML and/or XML, and the image data may include a slide presentation.

### BRIEF DESCRIPTION OF THE DRAWINGS

FIGS. 1-3 are block diagrams illustrating systems, methods, and devices according to embodiments of the present invention.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

As will be appreciated by those of skill in the art, the present invention may be embodied as methods or devices. Accordingly, the present invention may take the form of a hardware embodiment, a software embodiment or an embodiment combining software and hardware aspects. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items.

A display of a hand-held electronic device (such as a radiotelephone or a personal digital assistant) can be used to provide image data to a user of the handheld electronic device. In a radiotelephone, for example, a display on the body of the radiotelephone can show a telephone number dialed, a telephone number of a calling party (caller identification), information from an electronic address book stored in the radiotelephone, calendar information, e-mail, text messages, screens for electronic games, photographs, pictures, video clips, internet pages, etc. The size of the display of the hand-held electronic device, however, may be limited by the size of the electronic device. Accordingly, some of the image data may be difficult to view on the relatively small display typically provided on a hand-held electronic device.

Moreover, functionalities of hand-held electronic devices are expanding as processing power thereof increases. For example, word processor, spread-sheet, and presentation functions may be provided on a hand-held electronic device. More particularly, a slide presentation function may be provided on a hand-held electronic device using software such as PowerPoint™ provided by Microsoft Corp.

According to embodiments of the present invention, image data (such as a slide presentation) may be shown on the display of a hand-held electronic device. In addition or in an alternative, image data (such as a slide presentation) can be transmitted in an internet protocol format via a wireless link to an Internet protocol browser of an electronic display device providing a larger display. The electronic display device, for example, may be a television, a monitor, a personal computer, and/or a projector including an Internet protocol browser. Moreover, the electronic display device may provide a larger display than would otherwise be available on the portable electronic device.

The wireless link between the hand-held electronic device may be provided, for example, using a short range communications standard such as a WiFi Standard (according to an 802.11 standard), an infrared standard, and/or the BlueTooth standard. The BlueTooth standard is discussed, for example, by Sailesh Rathi in the reference entitled “BlueTooth Protocol Architecture” from Dedicated Systems Magazine, 2000 Q4, pages 28-33. Short range communications standards are also discussed in U.S. application Ser. No. 10/655,422 filed Sep. 4, 2003, and assigned to the assignee of the present invention.

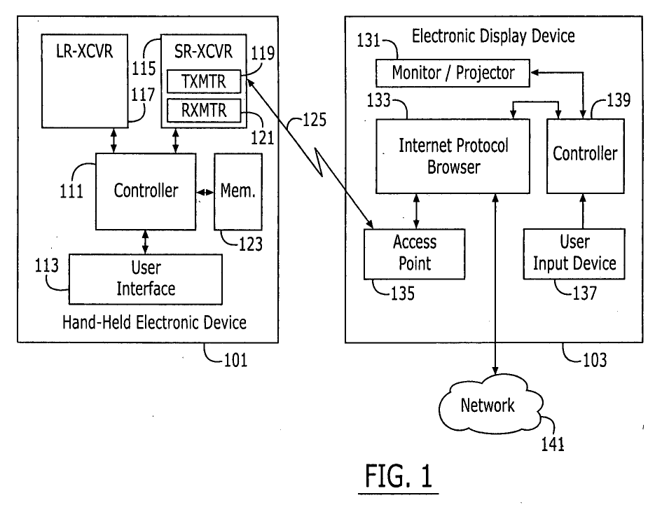

As shown in FIG. 1, systems, methods, and devices according to embodiments of the present invention may include a hand-held electronic device 101 (such as a radiotelephone and/or a personal digital assistant) and an electronic display device 103 such as a monitor and/or projector. More particularly, the hand-held electronic device 101 may include a controller 111, a user interface 113, a short range transceiver 115 (including transmitter 119 and receiver 121), memory 123 and a long range transceiver 117. The electronic display device 103 may include a display 131 (such as a monitor and/or projector), an Internet protocol browser 133, a wireless access point 135, a user input device 137, and a controller 139.

As discussed above, the hand-held electronic device 101 may be a personal digital assistant and/or a radiotelephone. Moreover, the user interface 113 may include a keypad, a display (such as a liquid crystal display), a touch sensitive display, a dial, a speaker, a directional key, and/or a microphone. According to conventional radiotelephone operations, voice data may be received from a speaker of the user interface 113, processed though controller 111, and transmitted to the radiotelephone network using the long range transceiver 117. Similarly, voice data may be received from the radiotelephone network using the long range transceiver 117, processed though controller 111, and reproduced using a speaker of user interface 113. In addition or in an alternative, the long range transmitter may provide packet switched data service communications, such as General Packet Radio Service (GPRS), with a communications network.

In addition or in another alternative, the hand-held electronic device 101 may provide functionality of a personal digital assistant. For example, the controller 111 may run one or a plurality of applications such as a contacts database, a calendar, an e-mail transmitter/receiver, a digital music player, a task list, an internet browser, a word processor, a spread-sheet, a PDF file viewer, and/or presentation application (such as PowerPoint™ by Microsoft Corp.) with input being received from and output being provided to the user interface 113. Accordingly, the hand-held electronic device 101 may provide both long range communications (such as radiotelephone and/or packet switched communications) and functionality of a personal digital assistant, or the hand-held electronic device 101 may provide functionality of a personal digital assistant without providing long range communications (in which case the long range transceiver 117 may be omitted).

The electronic display device 103 may be a free standing display device such as a projector, a monitor, or a television including an Internet protocol browser 133 therein, or the electronic display device 103 may be included as a component of a computing device such as a personal computer or a notebook computer. In some embodiments, the electronic display device 103 may be used to display image data received from the hand-held electronic device, image data received from a computer (such as a personal computer and/or a notebook computer), image data stored in the electronic display device, and/or image data received over a network 141 such as a local area network, a wide area network, and/or the internet. When displaying image data received over the network 141, for example, the internet protocol browser 133 may query a server through the network 141 under direction of the controller 139 based on input from the user input device 137 (which may be a pointing device such as a mouse, joy stick, track ball, directional key, touch sensitive pad, touch sensitive display, etc.) associated with the electronic display device 103. When displaying image data received from a computer, the controller 139 may be coupled directly with the computer providing the image data. An internet image projector is discussed, for example, in U.S. patent Publication No. US 2002/0175915.

When displaying data from the hand-held electronic device 101, a wireless link 125 can be established between the short range transceiver 115 of the hand-held electronic device 101 and the access point 135 of the electronic display device 103. The wireless link 125 may be provided, for example, using one or more of a WiFi standard (according to an IEEE 802.11 standard), a BlueTooth standard, and/or an infrared standard. Moreover, the wireless link 125 may include two or more wireless links provided according to the same or different communications standards. Accordingly, the short range transceiver 115 and the access point 135 may each include multiple transmitters and receivers operating according to the same or different communications standards.

For example, the wireless link 125 may include two sub-links with one sub-link being provided according to the BlueTooth standard and another sub-link being provided according to a WiFi standard. In an alternative, the wireless link 125 may include one sub-link provided according to the BlueTooth standard and another sub-link provided according to an infrared standard. In still another alternative, the wireless link 125 may include one sub-link provided according to the WiFi standard and another sub-link provided according to an infrared standard.

Image data may be stored in the memory 123 of the hand-held electronic device 101, and the controller 111 may be configured to provide the image data in an Internet protocol format for transmission by the transmitter 119 over the wireless link 125 to the access point 135 of the electronic display device 103. The image data can then be processed by the internet protocol browser 133 and the controller 139 and provided for viewing using display 131 (such as a cathode ray tube, liquid crystal display, plasma display, and/or projector).

The image data may be provided from the controller 111 of the hand-held electronic device 101 to the internet protocol browser 133 using an internet protocol format such as HyperText Markup Language (HTML) and/or Extensible Markup Language (XML). Accordingly, the internet protocol browser 133 of the electronic display device 103 may act as a client, and the controller 111 of the hand-held electronic device 113 may act as a server.

In addition, user input from the user interface 113 of the hand-held electronic device 101 may be used to control a pointer function of the internet protocol browser 133 of the electronic display device 131. Typically, the pointer function of an internet protocol browser is controlled using a user input device (such as a mouse, track ball, joy stick, touch sensitive display, touch sensitive pad, directional key, dial, etc.) physically associated with the device including the browser. In the electronic display device 101 of FIG. 1, the pointer function of the internet protocol browser 133 may be controlled from the user input device 137 when displaying image data from the network 141. In addition or in an alternative, the pointer function of the internet protocol browser 133 may be controlled by the controller 111 under the direction of the user interface 113 when displaying data from the network 141.

When displaying image data from the hand-held electronic device 101, the pointer function of the internet protocol browser 133 may be controlled from the user interface 113 of the hand-held electronic device 101. For example, pointer commands may be generated by the controller 111 responsive to user input through a joy stick, directional key, touch sensitive pad, touch sensitive display, dial, etc. of the user interface 113. More particularly, pointer commands may be generated at the controller 111 responsive to user input at the user interface 113 and transmitted over the wireless link 125 to the internet protocol browser 113, and the pointer function of the internet protocol browser 133 may be activated responsive to the pointer commands from the controller 111. The internet protocol browser 133 can retrieve image data from the controller 111 and provide the image data on the display 131 responsive to the pointer commands received from the controller 111 over the wireless link 125.

The pointer commands from the controller 111 may be buried in the stream of image data transmitted over the wireless link 125. Accordingly, the image data and the pointer commands may be transmitted using a single logical data stream, for example, using a WiFi standard, a BlueTooth standard, and/or an infrared standard. When using a BlueTooth standard to transmit the image data, for example, a Human Interface Device (HID) profile provided by the BlueTooth standard may be used to transmit the pointer commands with the image data. When using an internet protocol format such as HTML and/or XML, the pointer commands may be buried in the data stream used to transmit the image data using any wireless link standard. In an alternative, the image data and the pointer commands may be transmitted using different data streams provided using the same or different wireless link standards.

In one alternative, the controller 111 may move the pointer within the application under direction of the user interface 113, and the total image may be transferred to the electronic display device 103 without transferring the pointer commands to the electronic display device 103. In a second alternative, the controller 111 may move the pointer within the application under direction of the user interface 137, and the total image may be transferred to the electronic display device without transferring the pointer commands to the electronic display device 103. Accordingly, the pointer commands may need to be transferred from the electronic display device 103 to the hand-held electronic device 101. In a third alternative, the controller 111 may move the pointer in the browser 133 under the direction of the user interface 113. Accordingly, the pointer commands may be transferred from the hand-held device 101 to the electronic display device 103. In a fourth alternative, the controller 111 may move the pointer in the browser 113 under direction of the user interface 137. Accordingly, the pointer commands may be transferred from the electronic display device 103 to the hand-held electronic device 101 and back to the electronic display device 103. In a fifth alternative, the controller 139 may move the pointer in the browser 133 under the direction of the user interface 137. Accordingly, image data may be transmitted from the hand-held electronic device 101 to the electronic display device 103 without transmitting pointer commands.

According to embodiments of the present invention, image data may be stored in memory 123 of hand-held electronic device 101, transmitted from the hand-held electronic device over a wireless link 125 to an electronic display device 103 for viewing using display 131. More particularly, a presentation (such as a PowerPoint™ presentation) may be downloaded to memory 123 (such as over a USB connection) or generated by controller 111 (responsive to user input) and stored in memory 123. The presentation can then be easily transported in the hand-held electronic device to a meeting, and the presentation can be provided over a short range wireless link 125 to an electronic display device 103 in the meeting room. By providing display 131 as a projector or a monitor having a large screen, the presentation from the hand-held electronic device can be displayed to a large number of people.

Moreover, pointer commands from the user interface 113 of the hand-held electronic device 101 can be used to advance through slides of the presentation by activating a pointer function of the internet protocol browser 133. In addition, the image data can also be provided on a display of the user interface 113 of the hand-held electronic device 101 at the same time that the image data is provided on display 131 of the electronic display device 103. Accordingly, a presenter can use a display of the hand-held electronic device 101 to check the slide currently displayed without turning away from an audience to glance at the projected image.

In other embodiments, the electronic display device 103 may include a display 131 such as a monitor, cathode ray tube, liquid crystal display, plasma display, projector, etc. having an internet protocol browser 133 associated therewith. Image data can be transmitted over the wireless link 125 to allow the user to display personal information on the larger display 131 of the electronic display device 103 rather than using a much smaller display of the hand-held electronic device 101. For example, the user may elect to view e-mail, to view a calendar, to view game screens, to view an internet page down loaded to the hand-held electronic device, to view a photograph stored in the hand-held electronic device, to view a video clip stored in the hand-held electronic device, etc. using a remote electronic display device 103 as shown in FIG. 1.

The controller 139 of the electronic display device 103 may also police access to the internet protocol browser 133 through the access point 135. In other words, the controller 139 may only allow authorized hand-held electronic devices 101 to have access to the internet protocol browser 133. In a home or business environment, an authorized hand-held electronic device 101 may be assigned an access code so that the controller 139 of the electronic display device 131 can identify the presence of the authorized hand-held electronic device 101 and allow access to the internet protocol browser 133. For example, the previously assigned access code may be stored in memory 123 of the hand-held electronic device 101, and the previously assigned access code may be transmitted over the wireless link 125 responsive to either a user command provided at the user interface 113 or responsive to a query or beacon from the electronic display device 103. Moreover, in a closed or secure environment, the hand-held electronic device may automatically detect the presence of an available electronic device 103, and the application being run on the hand-held electronic device may be provided automatically on the display 131 of the available electronic display device 103.

In a public environment, the controller 139 of the electronic display device 103 may only allow access to previously authorized hand-held electronic devices 101 with access codes as discussed above. By recording access codes of hand-held electronic devices to which access has been granted, the controller 139 can track usage for billing purposes. By way of example, a radiotelephone may have a identification number such as a Mobile Identification Number (MIN) and/or an Electronic Serial Number (ESN) that can be used by the controller 139 to determine whether to grant access and/or track billing information. Other information, such as may be provided on a Secure Interface Module (SIM) card may also be used.

In an alternative, the controller 139 may grant access to a hand-held electronic device 101 based on entry and verification of payment information, such as a credit card number. For example, a user of a hand-held electronic device 101 may initiate a session with the electronic display device 103, and responsive to a query from the electronic display device 103, the user may enter credit card information through the user interface 113, and the credit card information may be transmitted over the wireless link 125.

The sharing of image data over the wireless link 125 may be initiated by a user of the hand-held electronic device 101 upon recognizing the physical presence of an electronic display device 103 and entering commands through the user interface 113 to establish the wireless link 125. In an alternative, the access point 135 may wirelessly transmit an identification beacon, and upon receipt of the beacon, the hand-held electronic device 101 may automatically establish the wireless link 125 (with appropriate authorization). In another alternative, a prompt may be provided on the user interface 113 to identify the available electronic display device 103 upon receipt of the beacon from the access point 135. In yet another alternative, a beacon may be transmitted by the hand-held electronic device 101, and upon receipt of the beacon, the access point 135 may respond with an indication of availability. Upon receipt of the indication of availability, the wireless link 125 may be established automatically, or a prompt may be provided at the user interface 113 with user input being required to establish the wireless link 125.

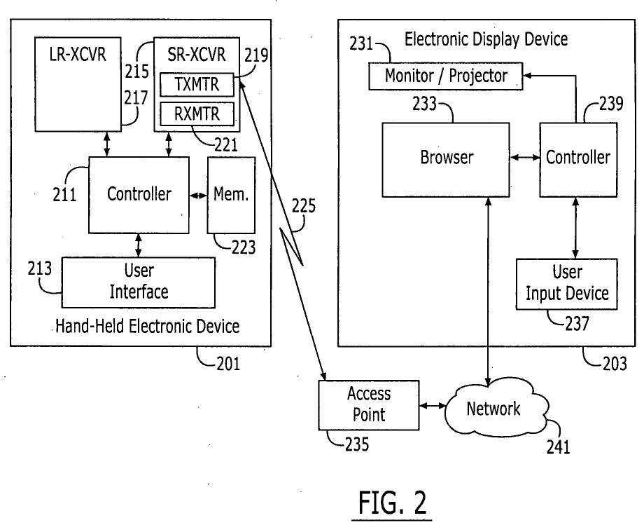

As shown in FIG. 2, systems, methods, and devices according to additional embodiments of the present invention may include a hand-held electronic device 201 (such as a radiotelephone and/or a personal digital assistant), an electronic display device 203 such as a monitor and/or projector, and a wireless access point 235 coupled to the electronic display device 203 through a network 241 such as a local area network, a wide area network, and/or the internet. More particularly, the hand-held electronic device 201 may include a controller 211, a user interface 213, a short range transceiver 215 (including transmitter 219 and receiver 221), memory 223, and a long range transceiver 217. The electronic display device 203 may include a display 231 (such as a monitor and/or projector), an Internet protocol browser 233, a user input device 237, and a controller 239.

As discussed above, the hand-held electronic device 201 may be a personal digital assistant and/or a radiotelephone. Moreover, the user interface 213 may include a keypad, a display (such as a liquid crystal display), a touch sensitive display, a touch sensitive pad, a dial, a speaker, a direction key, and/or a microphone. According to conventional radiotelephone operations, voice data may be received from a speaker of the user interface 213, processed though controller 211, and transmitted to the radiotelephone network using the long range transceiver 217. Similarly, voice data may be received from the radiotelephone network using the long range transceiver 217, processed though controller 211, and reproduced using a speaker of user interface 213. In addition or in an alternative, the long range transmitter may provide packet switched data service communications, such as General Packet Radio Service (GPRS), with a communications network.

In addition or in another alternative, the hand-held electronic device 201 may provide functionality of a personal digital assistant. For example, the controller 211 may run one or a plurality of applications such as a contacts database, a calendar, an e-mail transmitter/receiver, a digital music player, a task list, an internet browser, a word processor, a spread-sheet, a PDF file viewer, and/or presentation application (such as PowerPoint™ by Microsoft Corp.) with input being received from and output being provided to the user interface 213. Accordingly, the hand-held electronic device 201 may provide both long range communications (such as radiotelephone and/or packet switched communications) and functionality of a personal digital assistant, or the hand-held electronic device 201 may provide functionality of a personal digital assistant without providing long range communications (in which case the long range transceiver 217 may be omitted).

The electronic display device 203 may be a free standing display device such as a projector, a monitor, or a television including an Internet protocol browser 233 therein, or the electronic display device 203 may be included as a component of a computing device such as a personal computer or a notebook computer. In some embodiments, the electronic display device 203 may be used to display image data received from the hand-held electronic device 201, image data received from a computer (such as a personal computer and/or a notebook computer), image data stored in the electronic display device, and/or image data received from a server device over the network 241. When displaying image data received over the network 241, for example, the internet protocol browser 233 may query a server through the network 241 under direction of the controller 239 based on input from the user input device 237 (which may be a pointing device such as a mouse, track ball, joy stick, directional key, touch sensitive pad, touch sensitive display, etc.) associated with electronic display device 203. When displaying image data received from a computer, the controller 239 may be coupled directly with the computer providing the image data. An internet image projector is discussed, for example, in U.S. patent Publication No. US 2002/0175915.

When displaying data from the hand-held electronic device 201, a wireless link 225 can be established between the short range transceiver 215 of the hand-held electronic device 201 and the access point 235 coupled to the electronic display device 203 (either directly or through the network 241). The wireless link 225 may be provided, for example, using one or more of a WiFi standard (according to an IEEE 802.11 standard), a BlueTooth standard, and/or an infrared standard. Moreover, the wireless link 225 may include two or more wireless links provided according to the same or different communications standards. Accordingly, the short range transceiver 215 and the access point 235 may each include multiple transmitters and receivers operating according to the same or different communications standards.

For example, the wireless link 225 may include two sub-links with one sub-link being provided according to the BlueTooth standard and another sub-link being provided according to a WiFi standard. In an alternative, the wireless link 225 may include one sub-link provided according to the BlueTooth standard and another sub-link provided according to an infrared standard. In still another alternative, the wireless link 225 may include one sub-link provided according to the WiFi standard and another sub-link provided according to an infrared standard.

Image data may be stored in the memory 223 of the hand-held electronic device 201, and the controller 211 may be configured to provide the image data in an Internet protocol format for transmission by the transmitter 219 over the wireless link 225 to the access point 235 and over the network 241 to internet protocol browser 233 of the electronic display device 203. The image data can then be processed by the internet protocol browser 233 and the controller 239 and provided for viewing using display 231 (such as a cathode ray tube, liquid crystal display, plasma display, and/or projector).

According to embodiments of FIG. 2, the access point 235 may be located in a same room as the electronic display device 203 so that a short range wireless link can provide the interconnection while using the hand-held electronic device to give a presentation. The coupling between the access point 235 may be provided through the network 241, for example, for ease of connection. In an alternative, the access point 235 may be coupled directly to the electronic display device 203. In another alternative, the wireless link 225 may be a long range communications link (such as a radiotelephone link and/or a GPRS link) and the access point 235 may be a network base station. Accordingly, the access point 235 may not need to be located in a same room as the electronic display device 203, and a separate short range transceiver 215 may not be required.

The image data may be provided from the controller 211 of the hand-held electronic device 201 to the internet protocol browser 233 using an internet protocol format such as HyperText Markup Language (HTML) and/or Extensible Markup Language (XML). Accordingly, the internet protocol browser 233 of the electronic display device 203 may act as a client, and the controller 211 of the hand-held electronic device 213 may act as a server.

In addition, user input from the user interface 213 of the hand-held electronic device 201 may be used to control a pointer function of the internet protocol browser 233 of the electronic display device 231. Typically, the pointer function of an internet protocol browser is controlled using a user input device (such as a mouse, track ball, joy stick, directional key, touch sensitive pad, touch sensitive display, dial, etc.) physically associated with the device including the browser. In the electronic display device 203 of FIG. 2, the pointer function of the internet protocol browser 233 may be controlled from the user input device 237 when displaying conventional image data from the network 241. In addition or in an alternative, the pointer function of the internet protocol browser 233 may be controlled by the controller 211 under the direction of the user interface 213 when displaying data from the network 241.

When displaying image data from the hand-held electronic device 201, however, the pointer function of the internet protocol browser 233 may be controlled from the user interface 213 of the hand-held electronic device 201. For example, pointer commands may be generated by the controller 211 responsive to user input through a joy stick, directional key, touch sensitive pad, touch sensitive display, dial, etc. of the user interface 213. More particularly, pointer commands may be generated at the controller 211 responsive to user input at the user interface 213 and transmitted over the wireless link 225 to the internet protocol browser 213, and the pointer function of the internet protocol browser 233 may be activated responsive to the pointer commands from the controller 211. The internet protocol browser 233 can retrieve image data from the controller 211 and provide the image data on the display 231 responsive to the pointer commands received from the controller 211 over the wireless link 225.

The pointer commands from the controller 211 may be buried in the stream of image data transmitted over the wireless link 225. Accordingly, the image data and the pointer commands may be transmitted using a single logical data stream, for example, using a WiFi standard, a BlueTooth standard, and/or an infrared standard. When using a BlueTooth standard to transmit the image data, for example, a Human Interface Device (HID) profile provided by the BlueTooth standard may be used to transmit the pointer commands with the image data. When using an internet protocol format such as HTML and/or XML, the pointer commands may be buried in the data stream used to transmit the image data using any wireless link standard. In an alternative, the image data and the pointer commands may be transmitted using different data streams provided using the same or different wireless link standards.

In one alternative, the controller 311 may move the pointer within the application under direction of the user-interface 313, and the total image may be transferred to the electronic display device 303 without transferring the pointer commands to the electronic display device 303. In a second alternative, the controller 311 may move the pointer within the application under direction of the user interface 337, and the total image may be transferred to the electronic display device without transferring the pointer commands to the electronic display device 303. Accordingly, the pointer commands may need to be transferred from the electronic display device 303 to the hand-held electronic device 301. In a third alternative, the controller 311 may move the pointer in the browser 333 under the direction of the user interface 313. Accordingly, the pointer commands may be transferred from the hand-held device 301 to the electronic display device 303. In a fourth alternative, the controller 311 may move the pointer in the browser 333 under direction of the user interface 337. Accordingly, the pointer commands may be transferred from the electronic display device 303 to the hand-held electronic device 301 and back to the electronic display device 303. In a fifth alternative, the controller 339 may move the pointer in the browser 333 under the direction of the user interface 337. Accordingly, image data may be transmitted from the hand-held electronic device 301 to the electronic display device 303 without transmitting pointer commands.

According to embodiments of the present invention, image data may be stored in memory 223 of hand-held electronic device 201, transmitted from the hand-held electronic device over a wireless link 225 to an electronic display device 203 for viewing using display 231. More particularly, a presentation (such as a PowerPoint™ presentation) may be downloaded to memory 223 (such as over a USB connection) or generated by controller 211 (responsive to user input) and stored in memory 223. The presentation can then be easily transported in the hand-held electronic device to a meeting, and the presentation can be provided over a short range wireless link 225 to an electronic display device 203 in the meeting room. By providing display 231 as a projector or a monitor having a large screen, the presentation from the hand-held electronic device can be displayed to a large number of people.

Moreover, pointer commands from the user interface 213 of the hand-held electronic device 201 can be used to advance through slides of the presentation by activating a pointer function of the internet protocol browser 233. In addition, the image data can also be provided on a display of the user interface 213 of the hand-held electronic device 201 at the same time that the image data is provided on display 231 of the electronic display device 203. Accordingly, a presenter can use a display of the hand-held electronic device 201 to check the slide currently displayed without turning away from an audience to glance at the projected image.

In other embodiments, the electronic display device 203 may include a display 231 such as a monitor, cathode ray tube, liquid crystal display, plasma display, projector, etc. having an internet protocol browser 233 associated therewith. Image data can be transmitted over the wireless link 225 to allow the user to display personal information on the larger display 231 of the electronic display device 203 rather than using a much smaller display of the hand-held electronic device 201. For example, the user may elect to view e-mail, to view a calendar, to view game screens, to view an internet page down loaded to the hand-held electronic device, to view a photograph stored in the hand-held electronic device, to view a video clip stored in the hand-held electronic device, etc. using a remote electronic display device 203 as shown in FIG. 2.

The controller 239 of the electronic display device 203 may also police access to the internet protocol browser 233 through the access point 235. In other words, the controller 239 may only allow authorized hand-held electronic devices 201 to have access to the internet protocol browser 233. In a home or business environment, an authorized hand-held electronic device 201 may be assigned an access code so that the controller 239 of the electronic display device 231 can identify the presence of the authorized hand-held electronic device 201 and allow access to the internet protocol browser 233. For example, the previously assigned access code may be stored in memory 223 of the hand-held electronic device 201, and the previously assigned access code may be transmitted over the wireless link 225 responsive to either a user command provided at the user interface 213 or responsive to a query or beacon from the electronic display device 203. Moreover, in a closed or secure environment, the hand-held electronic device may automatically detect the presence of an available electronic device 203, and the application being run on the hand-held electronic device may be provided automatically on the display 231 of the available electronic display device 203.

In a public environment, the controller 239 of the electronic display device 203 may only allow access to previously authorized hand-held electronic devices 201 with access codes as discussed above. By recording access codes of hand-held electronic devices to which access has been granted, the controller 239 can track usage for billing purposes. By way of example, a radiotelephone may have an identification number such as a Mobile Identification Number (MIN) and/or an Electronic Serial Number (ESN) that-can be used by the controller 239 to determine whether to grant access and/or track billing information. Other information, such as may be provided on a Secure Interface Module (SIM) card may also be used.

In an alternative, the controller 239 may grant access to a hand-held electronic device 201 based on entry and verification of payment information, such as a credit card number. For example, a user of a hand-held electronic device 201 may initiate a session with the electronic display device 203, and responsive to a query from the electronic display device 203, the user may enter credit card information through the user interface 213, and the credit card information may be transmitted over the wireless link 225.

The sharing of image data over the wireless link 225 may be initiated by a user of the hand-held electronic device 201 upon recognizing the physical presence of an electronic display device 203 and entering commands through the user interface 213 to establish the wireless link 225. In an alternative, the access point 235 may be proximate to the electronic display device 203, and the access point 235 may wirelessly transmit an identification beacon, and upon receipt of the beacon, the hand-held electronic device 201 may automatically establish the wireless link 225 (with appropriate authorization). In another alternative, a prompt may be provided on the user interface 213 to identify the available electronic display device 203 upon receipt of the beacon from the access point 235. In yet another alternative, a beacon may be transmitted by the hand-held electronic device 201, and upon receipt of the beacon, the access point 235 may respond with an indication of availability. Upon receipt of the indication of availability, the wireless link 225 may be established automatically, or a prompt may be provided at the user interface 213 with user input being required to establish the wireless link 225.

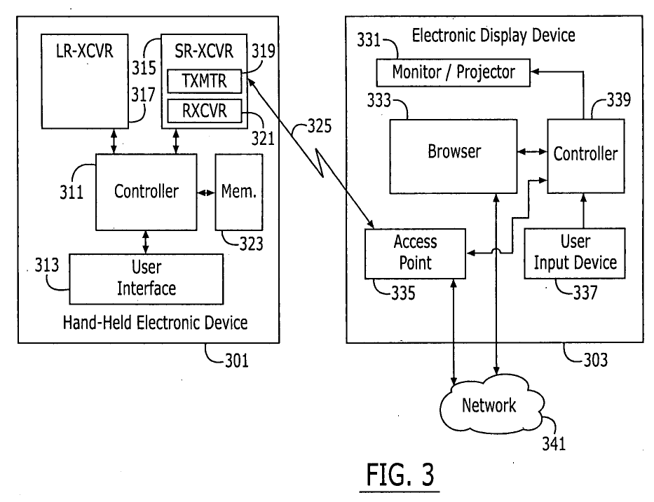

As shown in FIG. 3, systems, methods, and devices according to yet additional embodiments of the present invention may include a hand-held electronic device 301 (such as a radiotelephone and/or a personal digital assistant) and an electronic display device 303 such as a monitor and/or projector. More particularly, the hand-held electronic device 301 may include a controller 311, a user interface 313, a short range transceiver 315 (including transmitter 319 and receiver 321), memory 323, and a long range transceiver 317. The electronic display device 303 may include a display 331 (such as a monitor and/or projector), an Internet protocol browser 333, a wireless access point 335, a user input device 337, and a controller 339.

As discussed above, the hand-held electronic device 301 may be a personal digital assistant and/or a radiotelephone. Moreover, the user interface 313 may include a keypad, a display (such as a liquid crystal display), a touch sensitive display, a dial, a speaker, a directional key, and/or a microphone. According to conventional radiotelephone operations, voice data may be received from a speaker of the user interface 313, processed though controller 311, and transmitted to the radiotelephone network using the long range transceiver 317. Similarly, voice data may be received from the radiotelephone network using the long range transceiver 317, processed though controller 311, and reproduced using a speaker of user interface 313. In addition or in an alternative, the long range transmitter may provide packet switched data service communications, such as General Packet Radio Service (GPRS), with a communications network.

In addition or in another alternative, the hand-held electronic device 301 may provide functionality of a personal digital assistant. For example, the controller 311 may run one or a plurality of applications such as a contacts database, a calendar, an e-mail transmitter/receiver, a digital music player, a task list, an internet browser, a word processor, a spread-sheet, a PDF file viewer, and/or presentation application (such as PowerPoint™ by Microsoft Corp.) with input being received from and output being provided to the user interface 313. Accordingly, the hand-held electronic device 301 may provide both long range communications (such as radiotelephone and/or packet switched communications) and functionality of a personal digital assistant, or the hand-held electronic device 301 may provide functionality of a personal digital assistant without providing long range communications (in which case the long range transceiver 317 may be omitted).

The electronic display device 303 may be a free standing display device such as a projector, a monitor, or a television including an Internet protocol browser 333 therein, or the electronic display device 303 may be included as a component of a computing device such as a personal computer or a notebook computer. In some embodiments, the electronic display device 303 may be used to display image data received from the hand-held electronic device, image data received from a computer (such as a personal computer and/or a notebook computer), image data stored in the electronic display device, and/or image data received over a network 341 such as a local area network, a wide area network, and/or the internet. When displaying image data received over the network 341, for example, the internet protocol browser 333 may query a server through the network 341 under direction of the controller 339 based on input from the user input device 337 (which may be a pointing device such as a mouse, track ball, joy stick, directional key, touch sensitive pad, touch sensitive display, etc.) associated with the electronic display device 303. When displaying image data received from a computer, the controller 339 may be coupled directly with the computer providing the image data. An internet image projector is discussed, for example, in U.S. patent Publication No. US 2002/0175915.

When displaying data from the hand-held electronic device 301, a wireless link 325 can be established between the short range transceiver 315 of the hand-held electronic device 301 and the access point 335 of the electronic display device 303. The wireless link 325 may be provided, for example, using one or more of a WiFi standard (according to an IEEE 802.11 standard), a BlueTooth standard, and/or an infrared standard. Moreover, the wireless link 325 may include two or more wireless links provided according to the same or different communications standards. Accordingly, the short range transceiver 315 and the access point 335 may each include multiple transmitters and receivers operating according to the same or different communications standards.

For example, the wireless link 325 may include two sub-links with one sub-link being provided according to the BlueTooth standard and another sub-link being provided according to a WiFi standard. In an alternative, the wireless link 325 may include one sub-link provided according to the BlueTooth standard and another sub-link provided according to an infrared standard. In still another alternative, the wireless link 325 may include one sub-link provided according to the WiFi standard and another sub-link provided according to an infrared standard.

Image data may be stored in the memory 323 of the hand-held electronic device 301, and the controller 311 may be configured to provide the image data in an Internet protocol format for transmission by the transmitter 319 over the wireless link 325 to the access point 335 of the electronic display device 303. As shown in FIG. 3, the access point may be coupled with network 341, and the image data may be transmitted from the access point 335 through the network 341 to the internet protocol browser 333. In some cases, it may be easier to cross the network 341 than to communicate the image from the access point 335 to the internet protocol browser 333 through the controller 339. The image data can then be processed by the internet protocol browser 333 and the controller 339 and provided for viewing using display 331 (such as a cathode ray tube, liquid crystal display, plasma display, and/or projector).

The image data may be provided from the controller 311 of the hand-held electronic device 301 to the internet protocol browser 333 using an internet protocol format such as HyperText Markup Language (HTML) and/or Extensible Markup Language (XML). Accordingly, the internet protocol browser 333 of the electronic display device 303 may act as a client, and the controller 311 of the hand-held electronic device 313 may act as a server.

In addition, user input from the user interface 313 of the hand-held electronic device 301 may be used to control a pointer function of the internet protocol browser 333 of the electronic display device 331. Typically, the pointer function of an internet protocol browser is controlled using a user input device (such as a mouse, track ball, joy stick, directional key, touch sensitive pad, touch sensitive display, dial, etc.) physically associated with the device including the browser. In the electronic display device 301 of FIG. 3, the pointer function of the internet protocol browser 333 may be controlled from the user input device 337 when displaying image data from the network 341. In addition or in an alternative, the pointer function of the internet protocol browser 333 may be controlled by the controller 311 under the direction of the user interface 313 when displaying data from the network 341.

When displaying image data from the hand-held electronic device 301, the pointer function of the internet protocol browser 333 may be controlled from the user interface 313 of the hand-held electronic device 301. For example, pointer commands may be generated by the controller 311 responsive to user input through a joy stick, directional key, touch sensitive pad, touch sensitive display, dial, etc. of the user interface 313. More particularly, pointer commands may be generated at the controller 311 responsive to user input at the user interface 313 and transmitted over the wireless link 325 to the internet protocol browser 313, and the pointer function of the internet protocol browser 333 may be activated responsive to the pointer commands from the controller 311. The internet protocol browser 333 can retrieve image data from the controller 311 and provide the image data on the display 331 responsive to the pointer commands received from the controller 311 over the wireless link 325.

The pointer commands from the controller 311 may be buried in the stream of image data transmitted over the wireless link 325. Accordingly, the image data and the pointer commands may be transmitted using a single logical data stream, for example, using a WiFi standard, a BlueTooth standard, and/or an infrared standard. When using a BlueTooth standard to transmit the image data, for example, a Human Interface Device (HID) profile provided by the BlueTooth standard may be used to transmit the pointer commands with the image data. When using an internet protocol format such as HTML and/or XML, the pointer commands may be buried in the data stream used to transmit the image data using any wireless link standard. In an alternative, the image data and the pointer commands may be transmitted using different data streams provided using the same or different wireless link standards.

In one alternative, the controller 311 may move the pointer within the application under direction of the user interface 313, and the total image may be transferred to the electronic display device 303 without transferring the pointer commands to the electronic display device 303. In a second alternative, the controller 311 may move the pointer within the application under direction of the user interface 337, and the total image may be transferred to the electronic display device without transferring the pointer commands to the electronic display device 303. Accordingly, the pointer commands may need to be transferred from the electronic display device 303 to the hand-held electronic device 301. In a third alternative, the controller 311 may move the pointer in the browser 333 under the direction of the user interface 313. Accordingly, the pointer commands may be transferred from the hand-held device 301 to the electronic display device 303. In a fourth alternative, the controller 311 may move the pointer in the browser 313 under direction of the user interface 337. Accordingly, the pointer commands may be transferred from the electronic display device 303 to the hand-held electronic device 301 and back to the electronic display device 303. In a fifth alternative, the controller 339 may move the pointer in the browser 333 under the direction of the user interface 337. Accordingly, image data may be transmitted from the hand-held electronic device 301 to the electronic display device 303 without transmitting pointer commands.

According to embodiments of the present invention, image data may be stored in memory 323 of hand-held electronic device 301, transmitted from the hand-held electronic device over a wireless link 325 to an electronic display device 303 for viewing using display 331. More particularly, a presentation (such as a PowerPoint™ presentation) may be downloaded to memory 323 (such as over a USB connection) or generated by controller 311 (responsive to user input) and stored in memory 323. The presentation can then be easily transported in the hand-held electronic device to a meeting, and the presentation can be provided over a short range wireless link 325 to an electronic display device 303 in the meeting room. By providing display 331 as a projector or a monitor having a large screen, the presentation from the hand-held electronic device can be displayed to a large number of people.

Moreover, pointer commands from the user interface 313 of the hand-held electronic device 301 can be used to advance through slides of the presentation by activating a pointer function of the internet protocol browser 333. In addition, the image data can also be provided on a display of the user interface 313 of the-hand-held electronic device 301 at the same time that the image data is provided on display 331 of the electronic display device 303. Accordingly, a presenter can use a display of the hand-held electronic device 301 to check the slide currently displayed without turning away from an audience to glance at the projected image.

In other embodiments, the electronic display device 303 may include a display 331 such as a monitor, cathode ray tube, liquid crystal display, plasma display, projector, etc. having an internet protocol browser 333 associated therewith. Image data can be transmitted over the wireless link 325 to allow the user to display personal information on the larger display 331 of the electronic display device 303 rather than using a much smaller display of the hand-held electronic device 301. For example, the user may elect to view e-mail, to view a calendar, to view game screens, to view an internet page down loaded to the hand-held electronic device, to view a photograph stored in the hand-held electronic device, to view a video clip stored in the hand-held electronic device, etc. using a remote electronic display device 303 as shown in FIG. 3.

The controller 339 of the electronic display device 303 may also police access to the internet protocol browser 333 through the access point 335. In other words, the controller 339 may only allow authorized hand-held electronic devices 301 to have access to the internet protocol browser 333. In a home or business environment, an authorized hand-held electronic device 301 may be assigned an access code so that the controller 339 of the electronic display device 331 can identify the presence of the authorized hand-held electronic device 301 and allow access to the internet protocol browser 333. For example, the previously assigned access code may be stored in memory 323 of the hand-held electronic device 301, and the previously assigned access code may be transmitted over the wireless link 325 responsive to either a user command provided at the user interface 313 or responsive to a query or beacon from the electronic display device 303. Moreover, in a closed or secure environment, the hand-held electronic device may automatically detect the presence of an available electronic device 303, and the application being run on the hand-held electronic device may be provided automatically on the display 331 of the available electronic display device 303.

In a public environment, the controller 339 of the electronic display device 303 may only allow access to previously authorized hand-held electronic devices 301 with access codes as discussed above. By recording access codes of hand-held electronic devices to which access has been granted, the controller 339 can track usage for billing purposes. By way of example, a radiotelephone may have a identification number such as a Mobile Identification Number (MIN) and/or an Electronic Serial Number (ESN) that can be used by the controller 339 to determine whether to grant access and/or track billing information. Other information, such as may be provided on a Secure Interface Module (SIM) card may also be used.

In an alternative, the controller 339 may grant access to a hand-held electronic device 301 based on entry and verification of payment information, such as a credit card number. For example, a user of a hand-held electronic device 301 may initiate a session with the electronic display device 303, and responsive to a query from the electronic display device 303, the user may enter credit card information through the user interface 313, and the credit card information may be transmitted over the wireless link 325.

The sharing of image data over the wireless link 325 may be initiated by a user of the hand-held electronic device 301 upon recognizing the physical presence of an electronic display device 303 and entering commands through the user interface 313 to establish the wireless link 325. In an alternative, the access point 335 may wirelessly transmit an identification beacon, and upon receipt of the beacon, the hand-held electronic device 301 may automatically establish the wireless link 325 (with appropriate authorization). In another alternative, a prompt may be provided on the user interface 313 to identify the available electronic display device 303 upon receipt of the beacon from the access point 335. In yet another alternative, a beacon may be transmitted by the hand-held electronic device 301, and upon receipt of the beacon, the access point 335 may respond with an indication of availability. Upon receipt of the indication of availability, the wireless link 325 may be established automatically, or a prompt may be provided at the user interface 313 with user input being required to establish the wireless link 325.

In the drawings and specification, there have been disclosed typical preferred embodiments of the invention and, although specific terms are employed, they are used in a generic and descriptive sense only and not for purposes of limitation, the scope of the invention being set forth in the following claims. As used herein, the term “comprising” or “comprises” is open-ended, and includes one or more stated elements, steps, and/or functions.

Moreover, blocks of FIGS. 1-3 as discussed above represent various functionalities which may be implemented using hardware, software, and/or combinations thereof. Moreover, portions of functionalities of a particular block or all functionality of a particular block may be implemented in other blocks. For example, the memory of a hand-held electronic device may instead be implemented as a portion of the controller of the hand-held electronic device. Similarly, the internet protocol browser of an electronic display device may be implemented as a part of the controller of the electronic display device.

1. A hand-held electronic device comprising:
memory configured to store image data within the hand-held electronic device;
a transmitter configured to provide a wireless link with a remote electronic display; and
a controller coupled to the memory and to the transmitter wherein the controller is configured to provide the image data in an Internet protocol format and wherein the transmitter is configured to transmit the image data over the wireless link in the Internet protocol format.

2. A hand-held electronic device according to claim 1 further comprising:
a user interface coupled to the controller wherein the user interface is configured to accept user input of pointer commands and wherein the controller and transmitter are configured to transmit the pointer commands over the wireless link to the remote electronic display.

3. A hand-held electronic device according to claim 2 wherein the pointer commands are transmitted in the Internet protocol format.

4. A hand-held electronic device according to claim 2 wherein the pointer commands are transmitted in a format other than the Internet protocol format.

5. A hand-held electronic device according to claim 1 wherein the transmitter comprises a short range transmitter, the hand-held electronic device further comprising a long range transceiver configured to provide long-range communications.

6. A hand-held electronic device according to claim 1 wherein the transmitter is configured to provide a wireless link according to at least one of a WiFi standard, a BlueTooth standard, and/or an infrared standard.

7. A hand-held electronic device according to claim 1 wherein the Internet protocol format comprises at least one of HTML and/or XML.

8. A hand-held electronic device according to claim 1 wherein the controller further provides at least one of a contacts database, a calendar, an e-mail transmitter/receiver, a digital music player, a task list, and/or a wireless internet browser.

9. A hand-held electronic device according to claim 1 wherein the image data comprises a slide presentation.

10. An electronic display device comprising:
a display configured to display electronic data;
an Internet protocol browser, wherein the Internet protocol browser is configured to receive image data and pointer commands from a hand-held electronic device without a wired coupling to the hand-held electronic device, wherein the image data is received at the Internet protocol browser in an Internet protocol format, and wherein the Internet protocol browser is configured to provide the image data visually using the display responsive to the pointer commands from the hand-held electronic device.

11. An electronic display device according to claim 10 wherein the display comprises at least one of a monitor and/or a projector.

12. An electronic display device according to claim 10 wherein the pointer commands are received at the Internet protocol browser in the Internet protocol format.

13. An electronic display device according to claim 10 wherein the pointer commands are received at the Internet protocol browser in a format other than the Internet protocol format.

14. An electronic display device according to claim 10 wherein the Internet protocol format comprises at least one of HTML and/or XML.

15. An electronic display device according to claim 10 wherein the image data comprises a slide presentation.

16. A method of providing a visual presentation using a hand-held electronic device, the method comprising:
storing image data within the hand-held electronic device;
providing the image data in an Internet protocol format; and
transmitting the image data over a wireless link to a remote electronic display in the Internet protocol format.

17. A method according to claim 16 further comprising:
accepting user input of pointer commands; and
transmitting the pointer commands over the wireless link to the remote electronic display.

18. A method according to claim 17 wherein the pointer commands are transmitted in the Internet protocol format.

19. A method according to claim 17 wherein the pointer commands are transmitted in a format other than the Internet protocol format.

20. A method according to claim 16 wherein the image data is transmitted using a short range protocol, the method further comprising:
providing long-range wireless communications.

21. A method according to claim 16 wherein transmitting the image data comprises transmitting the image data using at least one of a WiFi standard, a BlueTooth standard, and/or an infrared standard.

22. A method according to claim 16 wherein the Internet protocol format comprises at least one of HTML and/or XML.

23. A method according to claim 16 further comprising:
providing at least one of a contacts database, a calendar, an e-mail transmitter/receiver, a digital music player, a task list, and/or a wireless internet browser.

24. A method according to claim 16 wherein the image data comprises a slide presentation.

25. A method of operating an electronic display device, the method comprising:
receiving image data and pointer commands from a hand-held electronic device without a wired coupling to the hand-held electronic device, wherein the image data is received in an Internet protocol format; and
providing the image data visually responsive to the pointer commands

26. A method according to claim 25 wherein providing the image data comprises providing the image data using at least one of a monitor and/or a projector.

27. A method according to claim 25 wherein the pointer commands are received at the Internet protocol browser in the Internet protocol format.

28. A method according to claim 25 wherein the pointer commands are received at the Internet protocol browser in a format other than the Internet protocol format.

29. A method according to claim 25 wherein the Internet protocol format comprises at least one of HTML and/or XML.

30. A method according to claim 25 wherein the image data comprises a slide presentation.
